(19) United States
(12) Patent Application Publication
(10) Pub. No.: US 2005/0162554 A1
(43) Pub. Date: Jul. 28, 2005

(54) Disk device integral type television receiver set and reproducing apparatus integral type television receiver set

(75) Inventor: Ryuji Takahashi, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Daito-shi (JP)

(21) Appl. No.: 11/021,508

(22) Filed: Dec. 23, 2004

(30) Foreign Application Priority Data
Dec. 25, 2003 (JP) JP2003-430862

(51) Int. Cl. H04N 5/76; H04N 5/781

(52) U.S. Cl. 348/552; 386/125

(57) ABSTRACT

In a disk device integral type television receiver set, when the transmission of data of a still image from a disk device side to a television receiver side is started, a timer is started. As a result that the display of the still image has been continued, when the time set in the timer has elapsed (times up), the CPU of the disk device side informs the CPU of the television receiver of this fact. The CPU of the television receiver side having been informed sends, to a signal selecting unit, a signal of selecting a broadcasting signal from a tuner. Thus, a broadcasting image which is a moving image is displayed on a CRT.

### BACKGROUND OF THE INVENTION

1. Field of the Invention

This invention relates to a disk device integral type television receiver set and a reproducing apparatus integral type television receiver set.

2. Description of the Related Art

In a DVD player or the like, when a still image data such as a disk menu screen of DVD is displayed for a long time on a CRT (cathode ray tube) of a television receiver, seizing of the screen occurs.

In order to solve this problem, it has been widely known that where
the display of the still image is continued for a prescribed time or longer, a screen saver is actuated to display a moving image on the CRT (for example, JP-A-2002-247528).

JP-A-11-4390 discloses that in order to prevent the screen seizing due to the “on-screen display” during CD reproduction, the position of the “on-screen display” is moved on the on the screen at regular time intervals. JP-A-8-287270 discloses that in a document creating apparatus having a function of a television receiver, with a television image having been displayed in a small size at a corner of the screen during document creation, when it is detected that key entry has not been made for a prescribed time, the television image is enlarged to the full screen and used as the screen saver.

However, these prior arts, in which the image data of the moving image for the screen saver, present a problem of an increase in the storage capacity of a memory. The method disclosed in JP-A-8-287270 presents a problem that if the still image displayed on the entire screen is moved, a part of the displayed contents disappears. This method may be not effective according to the display pattern of the still image. The method disclosed in JP-A-2002-247528, in which the television image must be displayed at a small size at the corner of the screen, presents a problem of a reduction in a display area for the image to be reproduced by DVD.

### SUMMARY OF THE INVENTION

This invention has been accomplished in order to solve the above problems. An object of this invention is to provide a disk device integral type television receiver set and a reproducing apparatus integral type television receiver set which can prevent seizing on the screen of a CRT without increasing the storage capacity where still image data are continuously transmitted from the disk device to a television receiver and displayed on the CRT of the television receiver.

In accordance with this invention, there is provided a disk device integral type television receiver set including a disk device for reproducing a DVD or CD with an image recorded thereon, and a television receiver provided with a CRT on which the image is displayed on the basis of an output signal from a signal selecting unit for selecting either the data reproduced by the disk device or a broadcasting signal tuned by a tuner and with a speaker for producing a voice, characterized in that the disk device and the television receiver have control units for controlling their operation, respectively; the control unit of the disk device monitors the time during which the disk device continuously transmits still image data to the television receiver, and, if the time exceeds a prescribed time, sends a predetermined message to the television receiver, and the control unit of the television receiver having received the predetermined message causes the signal selecting unit to select the broadcasting signal to be displayed on the CRT in place of the still image data. In this configuration, where the still image is continuously displayed on the CRT for a time exceeding a predetermined time, the broadcasting image which is a moving image is displayed. This prevents the seizing of the screen on the CRT without increasing the storage capacity.

Further, in accordance with this invention, there is provided a reproducing device integral type television receiver set including a reproducing device for reproducing a recording medium with an image recorded thereon, and a television receiver provided with a video outputting unit on which the image is displayed on the basis of an output signal from a signal selecting unit for either the data reproduced by the reproducing device or a broadcasting signal tuned by a tuner and with an audio output unit for producing a voice, characterized in that a control unit is provided for the operation of the reproducing device and the television receiver; and the control unit monitors the time during which the reproducing device continuously transmits still image data to the television receiver, and, if the time exceeds a prescribed time, causes the signal selecting unit to select the broadcasting signal to be displayed on the video output unit in place of the still image data. In this configuration, where the still image is continuously displayed on the video output unit for a time exceeding a predetermined time, the broadcasting image which is a moving image is displayed. This prevents the seizing of the screen on the video output unit without increasing the memory capacity.

This invention further includes a storage unit for storing a channel of the broadcasting signal tuned just before the still image data are displayed on the video output unit where the broadcasting signal is selected in place of the still image data, the control unit causes the tuner to tune the broadcasting signal at the channel. Thus, the channel with greater necessity is tuned. Otherwise, this invention includes a storage unit for storing a history of channels tuned by the tuner. Where the broadcasting signal is selected in place of the still image data, the control unit acquires the channel tuned on the basis of the history and causes the tuner to tune the broadcasting signal at the channel.

Thus, the channel with greater necessity or with the viewer's favorite is tuned.

Otherwise, this invention includes a storage unit for storing a pre-settable channel. Where the broadcasting signal is selected in place of the still image data, the control unit causes the tuner to tune the broadcasting signal at the preset channel. Thus, the viewer's favorite channel is tuned. Further, where the broadcasting signal is selected in place of the still image data, the control unit decreases sound volume from the audio output unit. Thus, viewer's attention can be called to that the seizing preventing processing is being carried out.

In accordance with this invention, even where still image data are continuously transmitted from a disk device to a television receiver, seizing of the screen of CRT of a television receiver can be prevented without increasing a storage capacity.

### BRIEF DESCRIPTION OF THE DRAWINGS

These and other objects and advantages of this invention will become more fully apparent from the following detailed description taken with the accompanying drawings in which:

FIG. 1 is a block diagram of a disk device integral type television receiver set;

FIG. 2 is a flowchart showing the operation of the side of a disk device;

FIG. 3 is a flowchart showing the operation of the side of a television receiver; and

FIG. 4 is a flowchart showing seizing preventing processing.

### DETAILED DESCRIPTION OF THE PREFERRED EMBODIMENTS

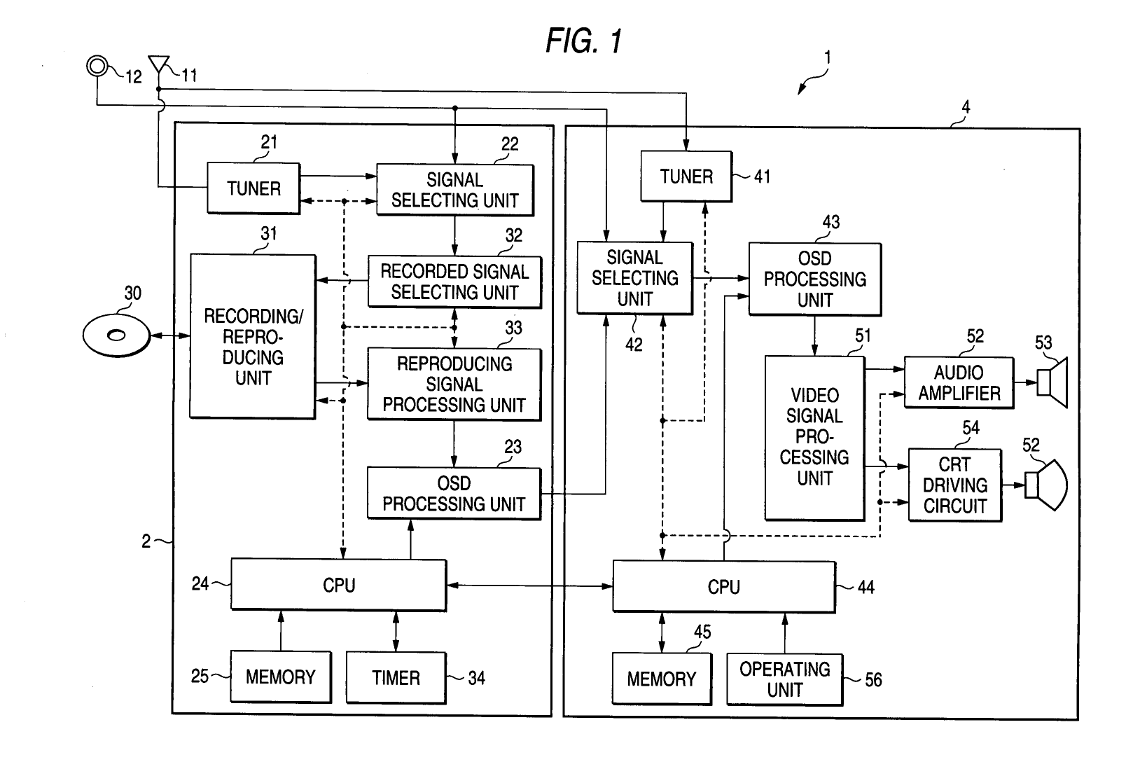

FIG. 1 is a block diagram of a disk device integral type television receiver set 1 according to this invention. The disk device integral type television receiver 1 includes a disk device 2 and a television receiver 4. First, the configuration of the disk device 2 will be explained. The disk device 2 is designed so that it can reproduce a disk 30 which may be various media such as DVD and CD and carry out recording for a writable disk 30.

A broadcasting signal received at an antenna 11 is tuned by a tuner 21. The tuned signal is transmitted to a signal selecting unit 22. In the signal selecting unit 22, the broadcasting signal or a signal from an external input terminal 12 is selected on the basis of the signal supplied from a CPU 24. The selected signal is transmitted to a recorded signal processing unit 32. The signal from the external input terminal 12 may be an output signal from other audio/video appliances, e.g. video tape recorder. In the recorded signal processing unit 32, the input signal is A/D converted and encoded in e.g. the MPEG-2 system. The encoded signal is recorded on a disk 30 by a recording/reproducing unit 31.

The recording/reproducing unit 31 includes a tray for placing the disk 30 and loading/unloading it, a recording head for recording data on the disk 30, a reproducing head for reproducing the data recorded on the disk 30 and a rotating/driving mechanism for rotating the disk during recording/reproducing. The recording/reproducing unit 31 is equipped with a sensor so that the presence or absence of the disk 30 and the status of the tray can be searched through CPU 24. The data of the disk 30 reproduced by the recording/reproducing unit 31 are decoded by a recorded signal processing unit 33 and thereafter D/A converted. The resultant analog data are supplied to an OSD processing unit 23.

The disk device 2 has a function of “on screen display” (hereinafter referred to as OSD) in which various messages for a viewer such as the presence/absence of the disk 30, status of the tray, reproducing time of the disk 30, etc. are displayed to be superposed on the reproduced data. The data relative to the OSD in a memory 25 are taken out by CPU 24 and supplied to the OSD processing unit 23. The OSD data superposed on the reproduced date in the OSD processing unit 23 are supplied to a signal selecting unit 42 of the television receiver 4.

The CPU 24 is connected with the memory 25 and a timer 34.

The memory 25 stores a program for controlling the operation of the disk device, the above OSD data, data (channel, recording starting time, recording time, etc.) employed when the broadcasting signal is recorded on the disk 30, various control data, etc. The memory 25 is also employed as an operation working area. The timer 34 sets time data from the CPU 24. When the set time elapses, the timer 34 informs the CPU 24 that the set time has elapsed (time's up).

The configuration of the television receiver 4 will be explained. The broadcasting signal received by the antenna 11 is tuned by a tuner 41 and supplied to a signal selecting unit 42.

In the signal selecting unit 42, on the basis of the signal supplied from a CPU 44, one of the broadcasting signal, signal from the external input terminal 12 and the signal from the OSD processing unit 23 of the disk device is selected. The output signal from the signal selecting unit 42 is supplied to an OSD processing unit 43. The OSD data supplied from a CPU 44 are superposed on the above output signal. In this OSD processing unit 43, the OSD data for the television receiver 4 are superposed. The superposed signal is supplied to a video signal processing unit 51 in which an audio signal is separated from a video signal, horizontal scanning signal and a vertical scanning signal. The audio signal is amplified by an audio amplifier 52 and outputted from a speaker 53 which is an audio output unit. The signal related to the image is supplied to a CRT 55, which is a video output unit, through a CRT driving unit 54.

An operation unit 56 includes a large number of operation keys provided on the front panel (not shown) of the disk device integral type television receiver set 1 and a remote controller (not shown) equipped with a large number of operation keys. The operation keys are composed of a key(s) dedicated to the operation of the disk device 2, a key(s) dedicated to the operation of the television receiver 4 and a key(s) commonly used for the operation of both apparatus. When any key is depressed, the corresponding signal is supplied to the CPU 44. In the CPU 44, the processing corresponding to the operation key is carried out. Further, the CPU 44 is connected to a memory 45. The memory 45 stores a program for controlling the operation of the television receiver 4, the above OSD data, various control data, etc. The memory 45 is also employed as an operation working area.

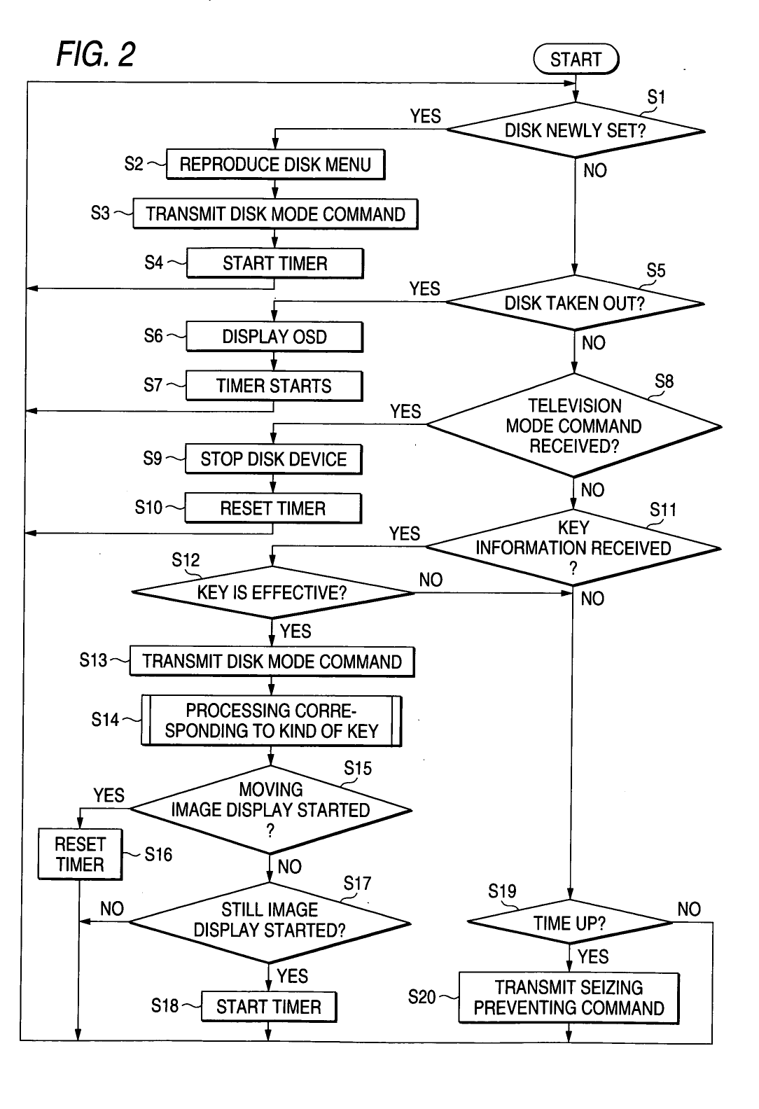

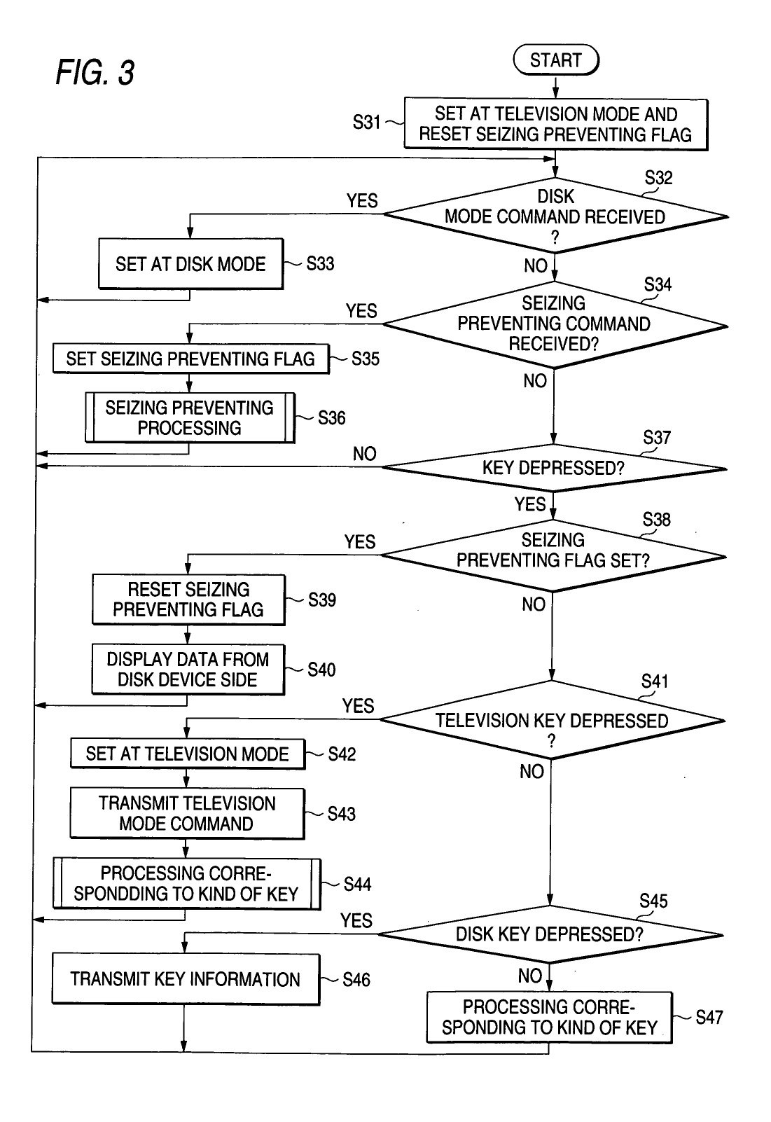

Next, along a flowchart, an explanation will be given of the operation of preventing the seizing of the CRT 55 according to this invention. FIG. 2 is a flowchart showing the operation on the side of the disk device 2. FIG. 3 is a flowchart showing the operation on the side of the television receiver 4. In the following description, it is assumed that the disk 30 is a DVD. Incidentally, it should be noted that the flowcharts illustrates not all the operations of the disk device integral type television receiver set 1 but only the operations relative to this invention. An explanation will be first given of the flowchart of FIG. 2.

First, when a power source is turned on, it is determined whether or not the disk 30 has been newly set on the tray so that it is placed in a reproducible status (S1). If the disk 30 is newly placed in the reproducible status, the disk menu of the DVD is reproduced (S2). The data relative to the disk menu are supplied to the television receiver 4 side through the reproduced signal processing unit 33 and the OSD processing unit 23. Since the disk menu is a still image, at this moment, the still image is displayed on the CRT 55. Next, the CPU 24 transmits a command (disk mode command) for setting the present mode at a disk mode to the CPU 44 of the television receiver 4 side. The disk mode is a mode in which the data (the reproduced data of the disk 30 or OSD data) supplied from the disk device 2 side are displayed on the CRT 55.

Next, by setting a prescribed time (e.g. five minutes) for the timer 34, the timer 34 is started (S1) and the processing process returns to S1. The time elapsed from when the still image is displayed on the CRT 55 is monitored on the basis of the time set for the timer 34. Incidentally, where the timer 34 has been already actuated, the setting time is set again so that the processing of starting the timer 34 is not carried out. This processing of starting the timer 34 applies to the other steps described later.

Where the CPU 24 returns to SI after the disk 30 has been newly set in SI and the steps from S2 to S4 have been carried out, the same disk 30 has been set. The determination in SI is therefore NO. Now, whether or not the disk 30 set in the tray should be taken out is determined (S5). If the disk 30 has been taken out, the OSD data (e.g. “the disk has been taken out from the tray”) read from the memory 25 by the CPU 24 are supplied to the OSD processing unit 23 and further displayed on the CRT 55. Since the OSD data are also the still image, at this moment, the display of the still image is started. Thus, in order to monitor the displaying time of the still image, the timer 34 is started(S7).

If it is not determined in S5 that the disk 30 has been taken out from the tray, it is further determined whether or not a command for setting the present mode at a television mode has been received from the television receiver 4 side (S8). This command is transmitted from the CPU 44 of the television receiver 4 side to the CPU 24 of the disk device 2 side when the present mode is set at the television mode on the side of the television receiver 4. The television mode is a mode in which the broadcasting signal is displayed on the CRT 55. For example, if a viewer who has been watching the reproduced data of the disk 30 depresses the “tuning key” of the operation unit 56 in order to watch the broadcasting program, the present mode is changed from the disk mode into the television mode. When the CPU 24 receives the television mode command, it stops the operation of the disk device (S9), resets the timer 34 (S10) so that the processing process returns to S1. This is because the broadcasting program which is a moving image has been displayed on the CRT 55, it has become unnecessary to monitor the displaying time of the still image.

If it is not determined in S8 that the command for setting the present mode at the television mode has been received, further it is determined whether or not key information employed for the operation of the disk device 2 has been received from the television receiver 4 side (S11). The key information is transmitted/received between the two CPUs 24 and 44. If it is determined that the key information has been received, it is further determined whether or not the key contained in the key information is effective (S12). According to the status of disk device 2 side, there are some acceptable and non-acceptable keys. The key which is not acceptable is excluded in this step.

If it is determined that the key is effective, CPU 24 sends a command for setting the present mode at the disk mode on the side of the television receiver (S13). Next, the processing corresponding to the kind of the key received is carried out. For example, in a state where the disk 30 has been set, when the “reproducing key” is received, the reproduction of the disk 30 is started. When “the menu key” for setting operation is depressed, the OSD data for the menu screen are supplied from the disk device 2 side to the television receiver 4 side and displayed on the CRT 55.

Next, it is determined whether or not the display of a moving image has been started by the processing in S14 (S15).

When it is determined that the display of the moving image has been started, it is not necessary to monitor the displaying time of the still image. So, the CPU 24 resets the timer 34 (516) so that the processing process returns to S1. The moving image is displayed when the reproduction of the disk 30 “has been started upon receipt of the” reproducing key. The moving image data are supplied to the television receiver 4 side and displayed on the CRT 55 thereof.

If it is not determined that the display of the moving image has been started in S15, it is determined whether the display of the still image has been started (S17). If it is determined that the display of the still image has been started, the timer 34 is started (S18) so that the processing process returns to S1. The displaying time of the still image is monitored by the timer 34. If it is not determined that the display of the still image has been started, this means that the processing not related to the display has been carried out in S14. So without being done anything, the processing process returns to S1.

If it is not determined in S11 that the key information has been received or it is not determined in S12 that the key is effective, it is determined whether or not the set time in the timer 34 has elapsed (time's up) (S19). The time's up of the timer 34 means that the still image has been continuously displayed for the time exceeding the time set in the timer 34. In the case of the time's up of the timer 34, the CPU 24 transmits, to the CPU 24 of the television receiver 4 side, a seizing preventing command (message that the time during which the still image data have been continuously displayed has exceeded the set time) (S20), and the processing process returns to S1. On the side of the television receiver 4 which has received this command, the processing for preventing the seizing on the CRT 55 is carried out. If it is not determined that the set time in timer 34 has elapsed (time's up), the processing process returns to Si without being done anything.

Now referring to FIG. 3, an explanation will be given of the operation on the side of the television receiver 4. First, when the power source is turned on, predetermined initializing processing is carried out. Thereafter, the present mode is set at the television mode and a seizing preventing flag is rest (S31). The data in this mode and the seizing preventing flag are stored in the memory 45. Next, it is determined whether or not a command for setting the present mode at the disk mode has been received from the CPU 24 of the disk device 2 side (S32). If received, the present mode is set at the disk mode (S33). At this time, the CPU 44 sends, to the signal selecting unit 42, a signal for selecting the data supplied from the disk device 2 side. Thus, the reproduced data of the disk 30 or the OSD data on the disk device 2 are displayed on the CRT 55. Thereafter, the processing process returns to S32.

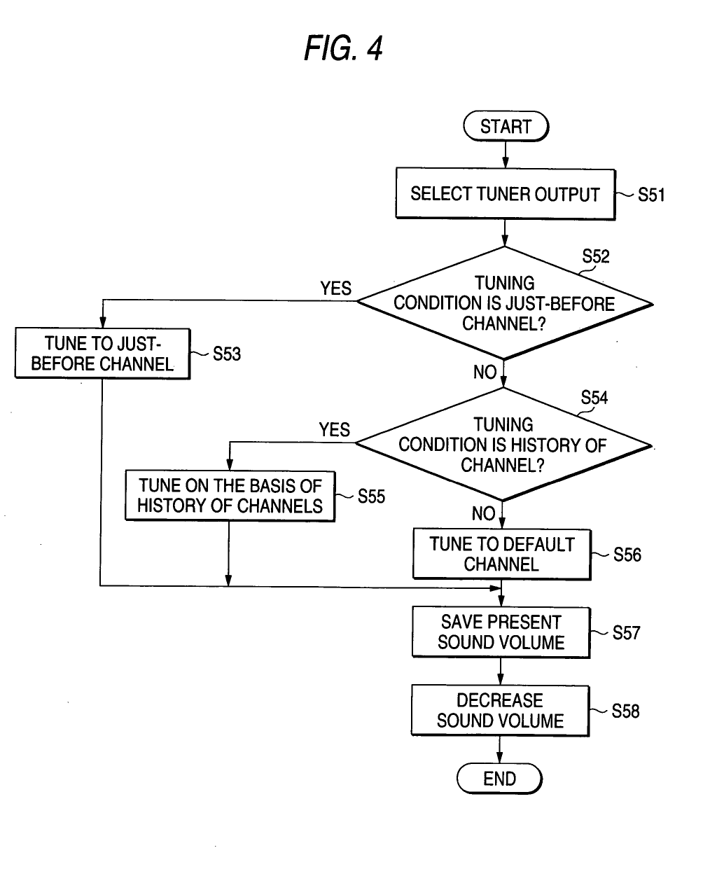

If it is not determined in S32 that the command for setting the present mode at the disk mode has been received, it is determined whether or not the seizing preventing command has been received from the CPU 24 of the disk device 2 side (S35). If received, the seizing preventing flag is set (S35). Thus, in order to preventing the seizing on the CRT 55, the seizing preventing processing shown in FIG. 4 is carried out (S36). Then, the processing process returns to S32. The seizing preventing processing will be described later.

If it is not determined that the seizing preventing command has been received, it is further determined whether or not the key has been depressed by the operation unit 56 (S37). If not depressed, the processing process returns to S32. If depressed, it is further whether or not the seizing preventing flag has been set (S38). If set, the seizing preventing flag is reset (S39). At this time, the CPU 44 sends, to the signal selecting unit 42, a signal for selecting the data supplied from the disk device 2 side. Thus, the data thus selected are displayed on the CRT 55 (S40). Thereafter, the processing process returns to S32 in this way, when any key is first depressed after the broadcasting program has been displayed on the CRT 55 for preventing its seizing, the display on the CRT 55 returns to the display before the broadcasting program is displayed.

If it is not determined in S38 that the seizing preventing flag has been set, it is further determined whether or not the key for the television receiver 4 has been depressed (S41). This determination is made on the basis of the code of the key depressed on the operation unit 56 and the present mode. If the key for the television receiver 4 has been depressed, the present mode is set at the television mode (S42). At this time, the CPU 44 sends, to the signal selecting unit 42, a signal for selecting the broadcasting signal. Thus, the broadcasting program is displayed on the CRT 55. In order to inform the disk device 2 side that the present mode has been set at the television mode, the CPU 44 transmits a television mode command to the CPU 24 of the disk device 2 side. Next, the processing corresponding to the kind of the key depressed (e.g. changing of the channel of the broadcasting program) is carried out. Then, the processing process returns to S32.

If it is not determined in S41 that the key for the television receiver 4, it is determined whether or not the key for the disk device 2 has been depressed (S45). If depressed, the corresponding key information is transmitted to the CPU 24 of the disk device 2 side (S46), and the processing process returns to S32. If it is not determined that the key for the disk device 2 has been depressed, since the key (e.g. key for increasing/decreasing sound volume) commonly used for both sides of the disk device 2 and the television receiver 4, the processing corresponding to the kind of the key is carried out (S47). Then, the processing process returns to S32.

Next, referring to FIG. 4, an explanation will be given of the seizing preventing processing. The seizing preventing processing is carried out where the still image data transmitted from the disk device 2 side have been displayed continuously for a prescribed time on the CRT 55. In this processing, the broadcasting image which is a moving image is displayed on the CRT 55. First, in order that the broadcasting image which is the moving image is displayed on the CRT 55, on the basis of the signal produced from the CPU 44, the signal selecting unit 42 is set to select the output from the tuner 41 (551). In this case, it should be noted that the present mode is not changed into the television mode. Next, it is determined whether or not the tuning condition previously set in the memory has been set at the channel just tuned before entering the disk mode (just-before channel). If the tuning condition has been set as such, the “just-before channel” stored in the memory 45 is transmitted to the tuner 41 so that the tuner 41 is tuned to this channel (S53).

If it is not determined in S52 that the tuning condition has been set at the “just-before channel”, it is determined whether or not the tuning condition is set to be based on the history of the channels (S54). If set as such, the history of e.g. 50 channels previously tuned is checked to find the channel tuned at the largest number of times. This channel is transmitted to the tuner 41. In this case, with the watching time as well as the channel data being stored in the memory 45, the channel with the longest watching time may be adopted. In any way, the tuning is done on the basis of the history of the channels stored in the memory 45.

If it is not determined in S54 that the tuning condition is set to be based on the history of the channels (S54), the tuner 41 is tuned to the channel (default channel) previously set in the memory 45 (S56). The default channel can be set in such a manner that a viewer operates the keys on the operating unit 56. For example, the viewer is most favorite channel is set as the default channel. Upon completion of the processing in S53, S55 and S55, the present sound volume is saved in the memory 45 (S57). Incidentally, when the reproduction of the disk 30 or the tuning for the broadcasting program is done afterward, the sound volume data thus saved are taken out and the audio amplifier 52 is controlled on the basis of the sound volume data. Next, the sound volume of the speaker 53 is decreased (inclusive of the sound volume of zero) on the basis of the signal supplied from the CPU 45 to the audio amplifier 52 (S58).

In the seizing preventing processing described above, since the broadcasting image which is the moving image is displayed on the CRT 55, the seizing on the screen of the CRT 55 can be prevented.

Further, as regards the tuning for the broadcasting image, it is done at any one of the “just-before channel”, channel determined on the basis of the tuning history and preset channel (default channel). The broadcasting image with greater necessity or with the viewer's favorite is therefore displayed at higher probability. This seizing preventing processing is more excellent than the conventional processing from the viewpoint of practicality. Further, by increasing the sound volume, viewer's attention can be called to that the seizing preventing processing is being carried out.

In the embodiment described hitherto, the explanation was made on the case where both sides of the disk device 2 and the television receiver 4 were caused to have the CPU 24, 44 and memory 25, 45, respectively to share their functions. However, this invention can be realized even when a single CPU and a single memory are provided commonly for both sides. Further, in the above embodiment, the explanation was made on the disk device integral type television receiver set 1 which permits the recoding/reproducing on the disk 30 such as DVD and CD which are the recording media. However, this invention can be applied to a reproducing apparatus integral type television receiver set in the recording medium is a video tape other than the disk.

In the above embodiment, although the explanation was made on the case where the video output unit is the CRT 55, as long as the video output unit may cause seizing like the CRT when the still image is displayed for a long time, this invention can be also applied to the reproducing device integral type television receiver set provided with such a video outputting unit.

Further, in the above embodiment, although the explanation was made on the case where according to the predetermined tuning condition, the tuning is done at one of the “just-before channel”, channel based on the tuning history and preset channel (default channel), not according to the tuning condition, any one of these three channels may be unconditionally adopted. Further, by setting the tuner 41 in a non-tuned state, a snow noise screen may be displayed on the CRT 55 to prevent the seizing of the CRT 55. Further, by selecting the signal from the external input terminal in a no-signal status, a jet-black screen may be displayed to prevent the seizing of the CRT 55.

Further, in the above embodiment, although the explanation was made on the case where the displaying time of the still image is monitored using the timer 34, by comparing the time when the still image has been displayed and the present time, the displaying time of the still image may be monitored. Incidentally, the timer 34, which controls the operation of this invention in cooperation with the CPU 24, is included in the control unit of this invention.

1. A disk device integral type television receiver set comprising:
a disk device for reproducing a DVD or CD with an image recorded thereon; and
a television receiver provided with a CRT on which the image is displayed on the basis of an output signal from a signal selecting unit for selecting either the data reproduced by the disk device or a broadcasting signal tuned by a tuner and with a speaker for producing a voices wherein
the disk device and the television receiver have control units for controlling their operation, respectively;
the control unit of the disk device monitors the time during which the disk device continuously transmits still image data to the television receiver, and, if the time exceeds a prescribed time, sends a predetermined message to the television receiver, and
the control unit of the television receiver having received the predetermined message causes the signal selecting unit to select the broadcasting signal to be displayed on the CRT in place of the still image data.

2. A reproducing device integral type television receiver set comprising:
a reproducing device for reproducing a recording medium with an image recorded thereon; and
a television receiver provided with a video outputting unit on which the image is displayed on the basis of an output signal from a signal selecting unit for either the data reproduced by the reproducing device or a broadcasting signal tuned by a tuner and with an audio output unit for producing a voice, wherein
a control unit is provided for the operation of the reproducing device and the television receiver; and
the control unit monitors the time during which the reproducing device continuously transmits still image data to the television receiver, and, if the time exceeds a prescribed time, causes the signal selecting unit to select the broadcasting signal to be displayed on the video output unit in place of the still image data.

3. The reproducing device integral type television receiver set according to claim 2, further comprising a storage unit for storing a channel of the broadcasting signal tuned just before the still image data are displayed on the video output unit, wherein
where the broadcasting signal is selected in place of the still image data, the control unit causes the tuner to tune the broadcasting signal at the channel.

4. The reproducing device integral type television receiver set according to claim 2, further comprising a storage unit for storing a history of channels tuned by the tuner, wherein
where the broadcasting signal is selected in place of the still image data, the control unit acquires the channel tuned on the basis of the history and causes the tuner to tune the broadcasting signal at the channel.

5. The reproducing device integral type television receiver set according to claim 2, further comprising a storage unit for storing a pre-settable channel, therein
where the broadcasting signal is selected in place of the still image data, the control unit causes the tuner to tune the broadcasting signal at the preset channel.

6. The reproducing device integral type television receiver set according to claim 2, wherein where the broadcasting signal is selected in place of the still image data, the control unit decreases sound volume from the audio output unit.
